(19) United States
(12) Patent Application Publication
(10) Pub. No.: US 2012/0048287 A1
(43) Pub. Date: Mar. 1, 2012

(54) Devices, Systems, and Methods for Cleaning Teeth

(76) Inventor: John L. White, Kent, WA (US)

(21) Appl. No.: 13/214,221

(22) Filed: Aug. 21, 2011

Related U.S. Application Data
(60) Provisional application No. 61/376,631, filed on Aug. 24, 2010.

(51) Int. Cl. A61C 17/00; A61C 19/02; A46B 15/00

(52) U.S. Cl. 132/200; 15/167.1; 132/310

(57) ABSTRACT

A device for cleaning teeth comprises a substrate and at least one projection. The substrate is made of a substrate material and defines a cavity shaped to receive at least a portion of a tongue. The at least one projection is made of a projection material and extends outwardly from the substrate. The substrate material and the projection material are non-toxic.

### TECHNICAL FIELD

The present invention relates to teeth cleaning devices, systems, and methods and, more particularly, to portable, single-use teeth devices that allow cleaning of teeth without access to toothbrush and water.

### BACKGROUND

Oral hygiene is the practice of keeping the mouth and teeth clean to avoid dental problems. The present invention is of primary interest in the context of the self-practice of oral hygiene by the patient.

Most commonly, teeth are self-cleaned cleaned by brushing, flossing, picking, chewing gums, and/or mouthwashes. The brushing of teeth typically employs a manual or electric toothbrush, toothpaste, and water for rinsing. Flossing involves drawing floss material between the teeth and along the juncture of the teeth and gums to remove food and plaque from places not easily accessible to the bristles of a tooth brush. Picking involves the insertion of a small pointed tool, typically made of wood or plastic, into the space between two adjacent teeth and against the gum to remove food and plaque and/or to stimulate the gums. The chewing of gums containing certain chemical compounds can promote oral hygiene by inhibiting the growth of certain bacteria. Mouthwashes are used to rinse the mouth with chemical compounds to materials to kill bacteria, and certain mouthwashes contain fluoride to protect against tooth decay.

Of the foregoing methods of cleaning the teeth and mouth, brushing, flossing, picking, and mouthwashes are typically not performed in public. In particular, brushing and the use of mouthwashes typically require the use of rinse water and a sink in which to spit rinse water and thus are typically performed in a bathroom in private. And, generally speaking, it is considered socially inappropriate to brush, floss, pick teeth, or use mouthwash outside of a private setting. The chewing of gums is considered socially acceptable in many, but not all, settings and is, in any event, not the most effective manner of actually cleaning teeth and gums.

A problem can arise when, during the day, the mouth and/or teeth require cleaning. The tools and/or materials required for certain forms of teeth cleaning (e.g., tooth brush, tooth paste, floss, dental pick, mouthwash) may not be available. And even if these tools or materials are available, it may be difficult achieve the privacy necessary to use these tools. T

The need thus exists for effective systems and methods for cleaning teeth that may be used throughout the day as necessary to clean teeth in a discrete, socially acceptable manner.

### SUMMARY

A device for cleaning teeth comprises a substrate and at least one projection. The substrate is made of a substrate material and defines a cavity shaped to receive at least a portion of a tongue. The at least one projection is made of a projection material and extends outwardly from the substrate. The substrate material and the projection material are non-toxic.

The present invention may also be implemented as a method of cleaning teeth comprising the following steps. A non-toxic substrate material is provided and formed into a substrate defining a cavity. A non-toxic projection material is provided and formed such that at least one projection outwardly extends from the substrate. The substrate material is displaced such that a tongue enters the cavity. The tongue is moved such that the projections engage the teeth.

The present invention may also be embodied as a system for cleaning teach comprising a case defining a case chamber and a plurality of cleaning devices. Each cleaning device comprises a substrate made of a substrate material and at least one projection made of projection material. The substrate defines a cavity shaped to receive at least a portion of a tongue. The at least one projection extends outwardly from the substrate. The substrate material and the projection material are non-toxic. At least one of the plurality of cleaning devices is arranged at least partly within a cavity of another of the plurality of cleaning devices to form a stack of cleaning devices. The stack of cleaning devices is arranged within the case chamber.

### BRIEF DESCRIPTION OF THE DRAWINGS

FIG. 1 is a perspective view of a first example tooth cleaning device of the present invention;

FIG. 2 is a side elevation, cross-section view of the first example tooth cleaning device;

FIG. 3 is a top plan view of a method of cleaning inside surfaces of bottom teeth using the first example cleaning device;

FIGS. 4-6 are side elevation, cross-section views of a method of cleaning the inside and outside surfaces of top and bottom teeth using the first example tooth cleaning device;

FIG. 7 is a side elevation, cross-section view of a second example tooth cleaning device of the present invention;

FIG. 8 is a side elevation, cross-section view of a third example tooth cleaning device of the present invention;

FIG. 9 is a top plan view of a method of cleaning interior surfaces of bottom teeth using the third example tooth cleaning device; and

FIGS. 10 and 11 are side elevation views of a plurality of fourth example tooth cleaning devices of the present invention and a storage system therefor depicted in closed and open configurations, respectively.

### DETAILED DESCRIPTION

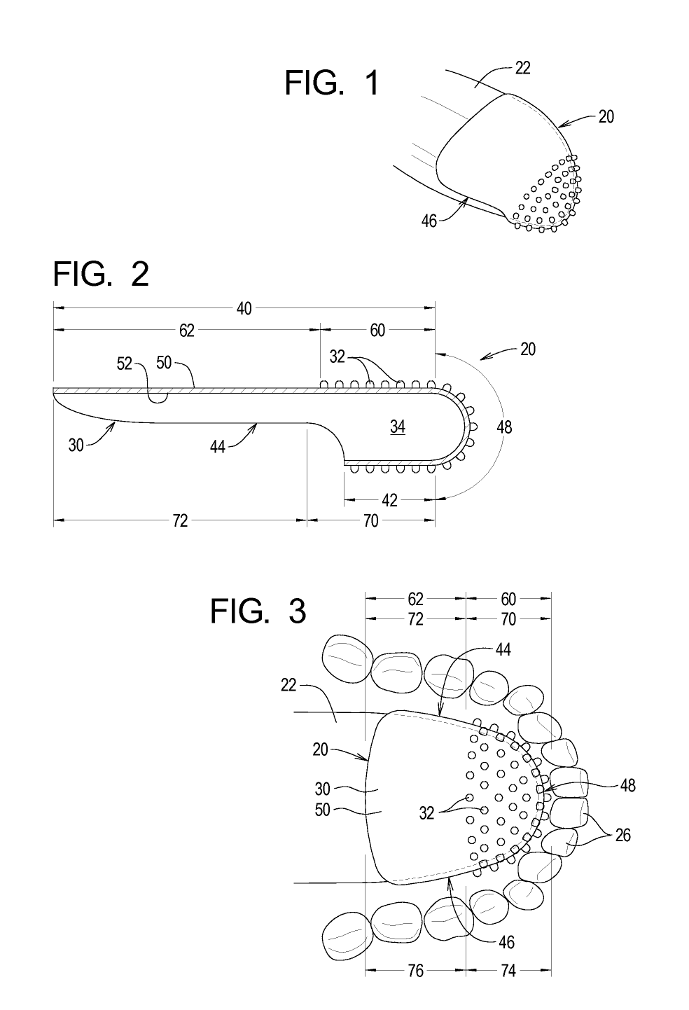

Referring initially to FIGS. 1-6 of the drawing, depicted at 20 therein is a first example tooth cleaning device constructed in accordance with, and embodying, the principles of the present invention. As shown in FIGS. 1 and 3-6, the cleaning device 20 is supported by a tongue 22 within a mouth 24 and is being used to clean teeth 26 within the mouth 24.

The example cleaning device 20 comprises a substrate 30 from which extends one or more projections 32. The example substrate 30 is shaped to define a cavity 34 adapted to receive at least a portion of the tongue 22. The one or more projections 32 extend outwardly from the substrate 30. Accordingly, with the tongue 22 received within the cavity 34, the cleaning device 20 is supported by the tongue 22 such that the one or more projections 32 extend outwardly from the tongue 22.

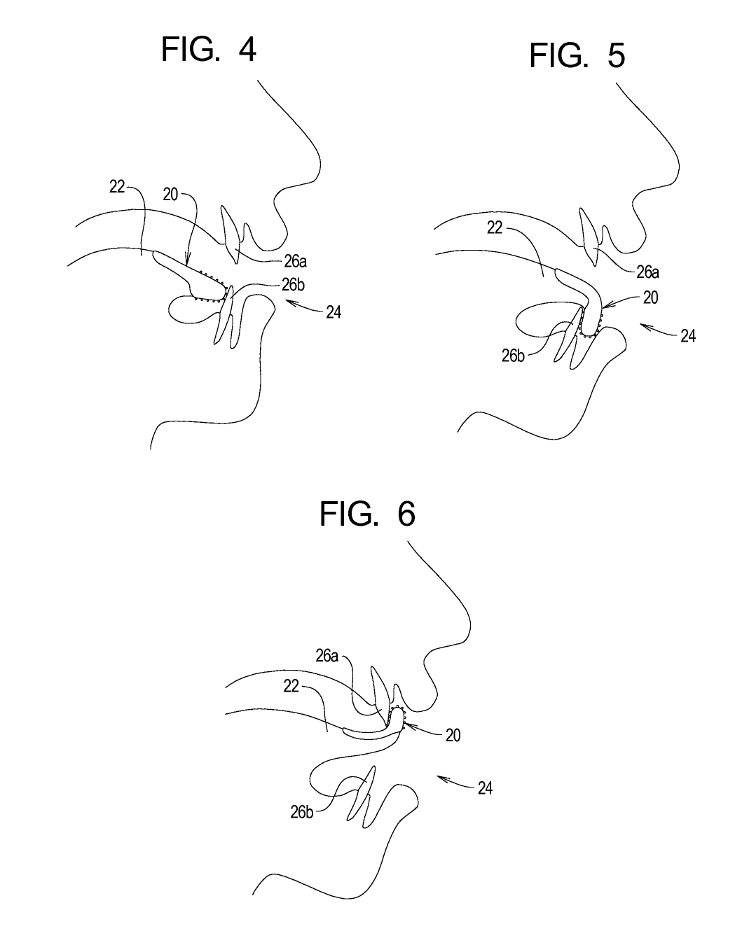

As shown in FIGS. 3-6, the tongue 22 can be moved within the mouth 24 such that the projections 32 come into contact with the teeth 26. In particular, as shown in FIGS. 3 and 4, the tongue 22 is moved such that the projections 32 come into contact with inside surfaces of the bottom teeth 26; a similar movement may be used to allow the projections 32 to come into contact with the inside surfaces of the upper teeth 26. In FIGS. 5 and 6, the tongue is moved such that the projections 32 come into contact with outside surfaces of the bottom and upper teeth 26, respectively.

The substrate 30 is made of a substrate material that is non-toxic and is capable of supporting the projections 32 in an outwardly extending orientation relative to the tongue 22 for at least a sufficient period of time to allow cleaning of the teeth 26 as described herein. The example projections 32 are made of a material that is non-toxic and capable of cleaning the teeth 26 by mechanical action such as polishing and/or abrading the surfaces thereof. The projections may be integrally formed with and/or embedded within the substrate 30. If the projections are integrally formed with the substrate 30, the substrate material and the substrate material may be at least partly the same.

In one example, the substrate 30 and projections 32 may be made of an edible material that eventually dissolves when exposed to the bodily fluids present within the mouth 24. In another example, the substrate 30 and/or projections 32 may be formed of or incorporates a material capable of assisting the cleaning of the surfaces of the teeth 26 when dissolved in the bodily fluids within the mouth 24. Further, the substrate 30 and/or projections 32 may incorporate materials capable of breath freshening when dissolved in the bodily fluids within the mouth 24.

With the foregoing general understanding of the principles of the present invention as embodied in the first example cleaning device 20, the details of the first example cleaning device 20 and other example cleaning devices will now be described.

As perhaps best shown in FIGS. 1-3, the substrate 30 of the first example cleaning device 20 comprises an upper portion 40, a lower portion 42, first and second side portions 44 and 46, and a tip portion 48. The example substrate 30 further defines an outer surface 50 and an inner surface 52.

The upper portion 40 of the example substrate 30 comprises a front region 60 and a rear region 62. Similarly, the example first side portion 44 defines a front region 70 and a rear region 72, while the second side portion 46 defines a front region 74 and a rear region 76.

The example projections 32 are formed such that they extend from the outer surface 50 in the front region 60 of the upper portion 40, in the lower portion 42, in the front regions 70 and 74 of the first and second side portions 44 and 46, and in the tip portion 48. In the first example cleaning device 20, projections are not included in the rear region 62 of the upper portion 40 and the rear regions 72 and 76 of the first and second side portions 44 and 46. These regions 62, 72, and 76 are thus provided primarily to increase the surface area of the first example cleaning device in contact with the tongue 22. The additional surface area in contact with the tongue 22 increases the adhesion between cleaning device 20 and the tongue 22, facilitating movement of the cleaning device 20 within the mouth 24 and around the teeth 26 as depicted in FIGS. 4-6.

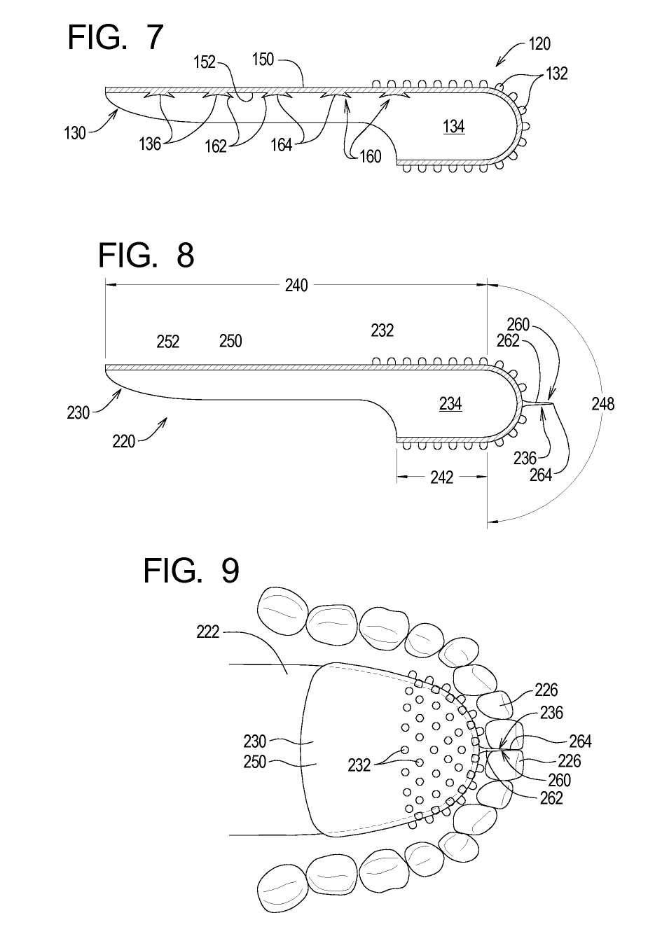

Referring now to FIG. 7 of the drawing, depicted at 120 therein is a second example tooth cleaning device constructed in accordance with, and embodying, the principles of the present invention. The second example cleaning device 120 is adapted to be supported by a tongue. The use of the second example cleaning device 120 is generally the same as that of the first example tooth cleaning device 20 as described above with reference to FIGS. 4-6.

The example cleaning device 120 comprises a substrate 130 from which extends one or more projections 132. Similar to the substrate 30 described above, the example substrate 130 is shaped to define a cavity 134 adapted to receive at least a portion of the tongue. The one or more projections 132 extend outwardly from the substrate 130. Accordingly, with the tongue received within the cavity 134, the cleaning device 120 is supported by the tongue such that the one or more projections 132 extend outwardly from the tongue.

FIG. 7 illustrates that one or more adhesive structures 136 extend from the substrate 130; these adhesive structures 136 are intended to increase the adhesion between the substrate 130 and the tongue.

The substrate 130 is similar to the substrate 30 described above and may be made of a material that is non-toxic and is capable of supporting the projections 132 in an outwardly extending orientation relative to the user's tongue for at least a sufficient period of time to allow cleaning of the teeth as described above. The projections 132 may be integrally formed with and/or embedded within the substrate 130. The example projections 132 are made of a material that is non-toxic and capable of cleaning the teeth 126 by mechanical action such as polishing and/or abrading the surfaces thereof.

Further like the substrate 30 described above, the second example substrate 130 and projections 132 may be made of an edible material that eventually dissolves when exposed to the bodily fluids present within the mouth 124. In another example, the substrate 130 and/or projections 132 may be formed of or incorporates a material such as xylitol capable of assisting the cleaning of the surfaces of the teeth 126 when dissolved in the bodily fluids within the mouth 124. The substrate 130 and/or projections 132 may further include materials such as fluoride capable of preventing dental cavities. Further, the substrate 130 and/or projections 132 may incorporate materials capable of breath freshening when dissolved in the bodily fluids within the mouth 124.

FIG. 7 further illustrates that the example substrate 130 further defines an outer surface 150 and an inner surface 152. The projections 132 extend from at least a portion of the outer surface 150, while the adhesive structures 136 extend from at least a portion of the inner surface 152. The example adhesive structures 136 take the form of small suction cups 160 defining a flexible rim 162 and an adhesive surface 164. As is conventional, deflection of the rim 162 increases adhesion between the surface 164 and the tongue inserted into the chamber 134.

Referring now to FIGS. 8 and 9 of the drawing, depicted at 220 therein is a third example tooth cleaning device constructed in accordance with, and embodying, the principles of the present invention. The third example cleaning device 220 is adapted to be supported by a tongue 222 and may be used to clean teeth 226 (FIG. 9) in generally the same manner as that of the first example tooth cleaning device 20 as described above with reference to FIGS. 4-6.

The example cleaning device 220 comprises a substrate 230 from which extends one or more projections 232. Similar to the substrate 30 described above, the example substrate 230 is shaped to define a cavity 234 adapted to receive at least a portion of the tongue 222. The one or more projections 232 extend outwardly from the substrate 230. Accordingly, with the tongue 222 received within the cavity 234, the cleaning device 220 is supported by the tongue 222 such that the one or more projections 232 extend outwardly from the tongue 222.

FIG. 8 illustrates that at least one pick structure 236 extends from the substrate 230; the example pick structure 236 is intended to facilitate the cleaning between the teeth 226.

The substrate 230 is similar to the substrate 30 described above and may be made of a material that is non-toxic and is capable of supporting the projections 232 in an outwardly extending orientation relative to the user's tongue 222 for at least a sufficient period of time to allow cleaning of the teeth as described above. The projections 232 may be integrally formed with and/or embedded within the substrate 230. The example projections 232 are made of a material that is non-toxic and capable of cleaning the teeth 226 by mechanical action such as polishing and/or abrading the surfaces thereof.

Further like the substrate 30 described above, the third example substrate 230 and projections 232 may be made of an edible material that eventually dissolves when exposed to the bodily fluids present within the mouth 224. In another example, the substrate 230 and/or projections 232 may be formed of or incorporates a material capable of assisting the cleaning of the surfaces of the teeth 226 when dissolved in the bodily fluids within the mouth 224. Further, the substrate 230 and/or projections 232 may incorporate materials capable of breath freshening when dissolved in the bodily fluids within the mouth 224.

FIG. 8 further illustrates that the example substrate 230 further defines an outer surface 250 and an inner surface 252. The projections 232 and the pick structure 236 extend from at least a portion of the outer surface 250. The example pick structure 236 takes the form of a tooth pick 260 defining a shaft 262 and a tip 264. The tooth pick 260 is sized and dimensioned to extend between adjacent teeth 226 to clean the surfaces of the adjacent teeth 226 that are difficult to reach using the projections 232.

Like the substrate 230 and/or projections 232, the pick structure 236 may be made of an edible material that eventually dissolves when exposed to the bodily fluids present within the mouth 224.

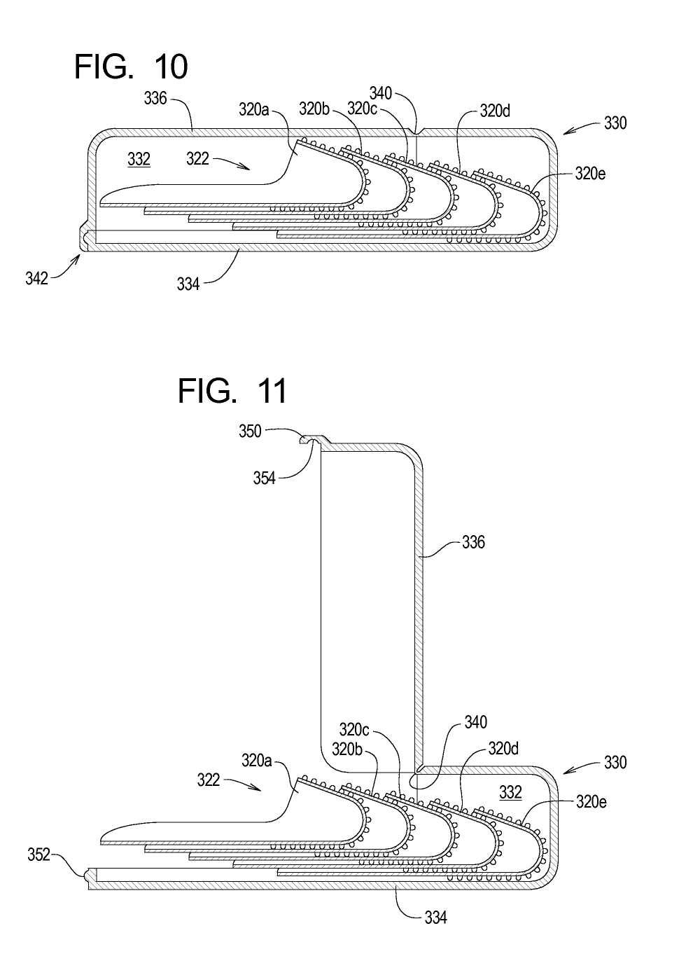

Turning now to FIGS. 10 and 11 of the drawing, depicted therein are a plurality of fourth example cleaning devices 320a, 320b, 320c, 320d, and 320e; these fourth example cleaning devices 320a, 320b, 320c, 320d, and 320e are constructed and used in a manner that is similar to the first example cleaning device 20 described above. The fourth example cleaning devices 320 are in addition shaped to allow one of the devices 320 to nest one within another of the devices 320 to form a stack 322, where the volume occupied by the stack 322 is minimized. The stack 322 is in turn disposed within a container 330 defining a chamber 332. The container 330 comprises a base portion 334 and a lid portion 336.

The example container 330 is integrally formed from a single injection molded part, and the base portion 334 and lid portion 336 are joined by a living hinge 340. The living hinge 340 allows the lid portion 336 to rotate relative to the base portion 334 between a closed position (FIG. 10) and an open position (FIG. 11). A latch assembly 342 is arranged to allow the base portion 334 to detachably engage the lid portion 336 to selectively hold the lid portion 336 in the closed position. However, the latch assembly 342 may be released to allow the lid portion 336 to be rotated from the closed position into the open position, thereby allowing access to the chamber 332.

FIG. 11 illustrates that the example latch assembly 342 comprises a detent lip 350 formed on the lid portion 336 and a detent projection 352 formed on the base portion 334. The detent lip 350 further defines a detent groove 354. The detent lip 350 is capable of deflecting slightly to allow the detent projection 352 to enter and exit the detent groove 354. When the detent projection 352 is within the detent groove 354, the latch assembly 342 is in its latched configuration. When the detent projection 352 is not within the detent groove 354, the latch assembly 342 is in its unlatched configuration.

When disposed within the chamber 332 and latch assembly 342 latching the lid portion 336 in the closed configuration, the stack 322 of fourth example cleaning devices 320 may be stored, shipped, displayed for retail sale, and carried in a substantially clean manner. When the user desires to use one of the devices 320, the latch assembly 342 is unlatched and the lid portion 336 rotated into the open position. Gripping the base portion 334 (and without touching any of the cleaning devices 320 by hand), the user may insert the tongue into the accessible cleaning device (320a in FIG. 11) and remove that cleaning device. The lid portion 336 may be returned to the closed position and the latch assembly 342 latched close the chamber 332. The entire container 330 and stack 322 of cleaning devices 320 may then be stored in a generally clean manner for the next use.

Given the foregoing, it should be apparent that the present invention may be embodied in forms other than those described above. For example, an example cleaning device can be made with both adhesive structures and one or more pick structures in addition to the projections.

What is claimed is:

1. A device for cleaning teeth comprising:
a substrate made of a substrate material, where the substrate defines a cavity shaped to receive at least a portion of a tongue;
at least one projection made of a projection material, where the at least one projection extends outwardly from the substrate; whereby
the substrate material and the projection material are non-toxic.

2. A device as recited in claim 1, in which the substrate material and the projection material dissolve when exposed to bodily fluids.

3. A device as recited in claim 1, in which the substrate material and the projection material are edible.

4. A device as recited in claim 1, in which the substrate material and the projection material are edible and dissolve when exposed to bodily fluids.

5. A device as recited in claim 1, in which:
the projections are integrally formed with the substrate; and
the substrate material and the projection material are the same.

6. A device as recited in claim 1, in which:
the substrate defines an inner surface and an outer surface;
the inner surface is adapted to engage the tongue; and
the projections extend outwardly from the outer surface.

7. A device as recited in claim 1, in which:
the substrate defines an upper portion and a lower portion; and
the cavity is arranged at least partly between the upper portion and the lower portion.

8. A device as recited in claim 1, in which:
a plurality of the projections outwardly extend from the upper portion of the substrate; and
a plurality of the projections outwardly extend from the lower portion of the substrate.

9. A device as recited in claim 1, in which:
the substrate defines a first side portion and a second side portion; and
the cavity is arranged at least partly between the first and second side portions.

10. A device as recited in claim 1, in which:
the substrate defines an upper portion, a lower portion, a first side portion, and a second side portion;
the cavity is arranged at least partly between the upper portion and the lower portion; and
the cavity is arranged at least partly between the first side portion and the second side portion.

11. A device as recited in claim 1, further comprising at least one suction structure extending inwardly from the substrate towards the cavity.

12. A device as recited in claim 1, further comprising at least one pick structure extending outwardly from the substrate.

13. A method of cleaning teeth comprising the steps of:
providing substrate material, where the substrate material is non-toxic;
forming the substrate material into a substrate defining a cavity;
providing projection material, where the projection material is non-toxic;
forming the projection material into at least one projection such that the at least one projection outwardly extends from the substrate;
displacing the substrate material such that a tongue enters the cavity;
moving the tongue such that the projections engage the teeth.

14. A method as recited in claim 13, further comprising the steps of:
allowing the substrate material and the projection material dissolve; and
swallowing the dissolved substrate material and projection material.

15. A system for cleaning teeth comprising:
a case defining a case chamber;
a plurality of cleaning devices, where each cleaning device comprises
a substrate made of a substrate material, where the substrate defines a cavity shaped to receive at least a portion of a tongue, and
at least one projection made of a projection material, where the at least one projection extends outwardly from the substrate, where
the substrate material and the projection material are non-toxic; whereby
at least one of the plurality of cleaning devices is arranged at least partly within a cavity of another of the plurality of cleaning devices to form a stack of cleaning devices; and
the stack of cleaning devices is arranged within the case chamber.

16. A system as recited in claim 15, in which:
the case defines a base portion and a lid portion;
the lid portion is connected to the base portion for rotation between closed and open positions; and
when the lid portion is in the open position, a user may insert a tongue into the case chamber and into a cavity of one of the plurality of cleaning devices forming the stack of cleaning devices.

17. A system as recited in claim 15, in which the substrate material and the projection material are edible and dissolve when exposed to bodily fluids.

18. A system as recited in claim 15, in which:
each substrate defines an upper portion and a lower portion;
a plurality of the projections outwardly extend from the upper portion of the substrate; and
a plurality of the projections outwardly extend from the lower portion of the substrate.
